(19) United States
(12) Patent Application Publication
(10) Pub. No.: US 2025/0352839 A1
(43) Pub. Date: Nov. 20, 2025

(54) Extinguishing System

(71) Applicant: Albert Orglmeister, Wiesbaden (DE)

(72) Inventor: Albert Orglmeister, Wiesbaden (DE)

(21) Appl. No.: 18/866,577

(22) PCT Filed: May 10, 2023
(86) PCT No.: PCT/EP2023/062383

§ 371 Date: Nov. 18, 2024

(30) Foreign Application Priority Data
May 29, 2022 (DE) 102022113477.6

(51) Int. Cl. A62C 37/40

(52) U.S. Cl. CPC A62C 37/40

(57) ABSTRACT

An extinguishing system comprises: —at least one extinguishing agent sprayer (8) that is able to be rotated about a mounting axis (19) and is able to be pivoted about a pivot axis by means of at least one motor and is connected to an extinguishing agent line in order to be supplied with extinguishing agent, —at least one camera (7) that is able to be rotated at least about a mounting axis (17) by means of at least one motor (20), —an electronic controller (10) that comprises at least one storage unit (12) in which at least geometric basic data of the relevant area and/or data of the extinguishing agent sprayer (8) are stored so as to be able to be read, and a computer module (13) for data processing, —an input device, connected to the controller (10), for inputting data and/or for controlling the extinguishing agent sprayer (8) and the camera (7) and—a screen, connected to the controller (10), for displaying images from the camera (7). The mounting axis (17) of the camera (7) and the mounting axis (19) of the extinguishing agent sprayer (8) are oriented parallel to one another, and the optical axis (21) of the camera (7) is oriented at a defined starting angle with respect to the mounting axis (17), wherein the starting angle is stored in the storage unit (12).

### CROSS REFERENCE TO RELATED APPLICATIONS

This application is the U.S. national stage of International Application No. PCT/EP2023/062383, filed on 2023 May 10. The international application claims the priority of DE 102022113477.6 filed on 2022 May 29; all applications are incorporated by reference herein in their entirety.

### BACKGROUND

The invention relates to an extinguishing system having
at least one extinguishing agent sprayer that is able to be rotated about a mounting axis by means of at least one motor and is connected to an extinguishing agent line in order to be supplied with extinguishing agent,
at least one camera that is able to be rotated at least about a mounting axis by means of at least one motor,
an electronic controller that comprises at least one storage unit in which at least geometric basic data of the relevant area and/or data of the extinguishing agent sprayer are stored so as to be able to be read, and a computer module for data processing,
an input device, connected to the controller, for inputting data and/or for controlling the extinguishing agent sprayer and the camera, and
a screen, connected to the controller, for displaying images from the camera.

Extinguishing systems are known, for example, from DE 102016 104349 A1, DE 102011 053 373 A1, and DE 21 2010 000 060 U1, and are increasingly being used to protect waste bunkers and storage facilities both outdoors and indoors. For fire detection, or early fire detection, these predominantly automatic extinguishing systems comprise at least one camera, which is usually arranged at a top side, for example on a room ceiling or on a mast or the like, and is pivoted over the area to be monitored. If a fire source, glowing embers, or an area with an unusually high temperature for the material monitored is detected, indicating that a fire may be starting in a deeper area below the surface that can be monitored thermographically, the controller directs an extinguishing agent sprayer at this fire source and opens a valve so that the extinguishing agent flows out at a relatively high pressure and in a relatively large quantity. Due to inaccuracies in the detection of the source of the fire and in the aiming of the extinguishing agent sprayer, the extinguishing agent sprayer is often pivoted vertically and/or horizontally in order to extinguish the source of the fire. The exact positioning of the camera and/or the extinguishing agent sprayer proves to be difficult in practice, since these devices can only be mounted with deviations from an exact vertical position, which can lead to considerable deviations from optimal conditions in the case of pivot movements and an extinguishing agent discharge to a fire source many meters away from the extinguishing agent sprayer. In addition, the hydraulic conditions of the extinguishing agent on site, i.e., in the installation situation, are often unknown and can only be calculated approximately.

To control the extinguishing agent sprayer, it is coupled with a so-called position control panel or joystick. If the position control panel is designed as a so-called tablet, i.e., a computer with a touchscreen, a user sees the images taken by the camera on the display and can mark a target for the extinguishing agent by simply touching it, for example with a finger or an active pen, or can correspondingly adjust the extinguishing agent sprayer accordingly if the target is not hit automatically.

US 2004/0 129 434 A1 and CN 20 652 6437 U disclose automatic extinguishing systems with movable IR sensors for detecting the source of a fire and with an extinguishing agent sprayer.

WO 2004/052466 A1 shows another extinguishing system with a fixed camera and a manually controllable extinguishing agent sprayer.

### SUMMARY

An extinguishing system comprises: —at least one extinguishing agent sprayer (8) that is able to be rotated about a mounting axis (19) and is able to be pivoted about a pivot axis by means of at least one motor and is connected to an extinguishing agent line in order to be supplied with extinguishing agent, —at least one camera (7) that is able to be rotated at least about a mounting axis (17) by means of at least one motor (20), —an electronic controller (10) that comprises at least one storage unit (12) in which at least geometric basic data of the relevant area and/or data of the extinguishing agent sprayer (8) are stored so as to be able to be read, and a computer module (13) for data processing, —an input device, connected to the controller (10), for inputting data and/or for controlling the extinguishing agent sprayer (8) and the camera (7) and—a screen, connected to the controller (10), for displaying images from the camera (7). The mounting axis (17) of the camera (7) and the mounting axis (19) of the extinguishing agent sprayer (8) are oriented parallel to one another, and the optical axis (21) of the camera (7) is oriented at a defined starting angle with respect to the mounting axis (17), wherein the starting angle is stored in the storage unit (12).

### DETAILED DESCRIPTION

The invention is based on the object of creating an extinguishing system of the type mentioned above, which, due to the installation situation, enables faster data processing with a smaller data volume than the prior art.

Furthermore, it is an object of the invention to carry out fire fighting, or early fire fighting, in such a way that extinguishing agent is discharged in a relatively small amount in a relatively targeted manner.

The objects are achieved in that the mounting axis of the camera and the mounting axis of the extinguishing agent sprayer are aligned parallel to each other and the optical axis of the camera is aligned at a defined starting angle to the mounting axis, wherein the starting angle is stored in the storage unit.

Due to the parallel alignment of the mounting axis of the extinguishing agent sprayer and the mounting axis of the camera, as well as the defined alignment of the camera, the volume of data to be processed by the controller, in particular the image data of the camera, is substantially reduced, and an error in the controlling of the extinguishing agent sprayer to the detected source of the fire or the recorded and evaluated hot spot in the monitored room is limited to the offset of the extinguishing agent sprayer to the camera, wherein this error is negligible, particularly in view of the volume of extinguishing agent discharged.

The setting angles, as well as the coordinates or positions at which the camera and the extinguishing agent sprayer are attached, are stored in the memory unit of the controller. Furthermore, the positioning of the extinguishing monitor, i.e., its alignment with the source of the fire, the so-called hotspot, can be carried out quickly with a reduced computing effort compared to the prior art, wherein speed is given a higher priority than the local error, which can be corrected if necessary by manually adjusting the extinguishing monitor using any input device or by automatically adjusting the extinguishing monitor or enlarging the extinguishing area based on feedback from the camera that the target has not been hit, wherein the input device comprises for example a joystick or a mouse or a keyboard. To simplify the control of the adjustment motors of the extinguishing monitor, in particular in stressful situations, a touchscreen is connected to the control as an input device and/or screen, an image of the area of the camera relevant to the extinguishing system being displayed on the screen. The extinguishing agent sprayer can, for example, be moved manually by an operator of the otherwise automatic extinguishing system by using his finger, for example, to change the point of impact of the extinguishing agent shown on the screen.

The mounting axis of the camera and the mounting axis of the extinguishing agent sprayer are aligned parallel to each other. In terms of height, the camera and the extinguishing agent sprayer can be offset from each other, for example by about 1 m, so that the extinguishing agent sprayer does not for example destroy the camera with extinguishing agent. The difference in height is relatively unimportant for the actual accuracy.

Of course, data from the extinguishing agent sprayer are stored in the storage unit, which data can include, for example, standard sprayer curves determined by the manufacturer.

The optical axis of the camera is offset from the mounting axis by 10° to 170°, preferably by 40° to 50°, particularly preferably by approx. 45°, but can also be pivoted as desired.

If a source of fire or similar hot spot can be identified in the image of the camera displayed on the screen, for example by means of an image processing device, the controller calculates the coordinates of this point and controls the motors assigned to the extinguishing agent sprayer in such a way that the extinguishing agent sprayer is aligned in such a way that the extinguishing agent hits exactly the calculated point.

The camera can be designed as a thermal imaging camera or a video camera with position-providing flame or smoke detection, without departing from the scope of the invention.

In order to ensure that fire sources can be clearly identified and distinguished from other hot spots, for example microphones can also be installed in the room to be monitored which enable the controller to detect engine noises, or the image processing device can be designed to detect vehicles, so that a hot engine or exhaust of a vehicle is recognized as such and not as a source of fire that needs to be extinguished.

In order to capture the space to be monitored with the camera as completely as possible, the camera is conveniently driven from a zero position in an oscillating or rotating manner around the mounting axis. For example, the camera can be rotated radially by up to 360° around the mounting axis from a zero position. Accordingly, a distorted or relatively round image is displayed on the screen, which is then assembled and displayed, for example as described below.

In order to monitor a larger area, the camera can be pivoted from the defined starting angle to the mounting axis by a defined pivot angle in the direction of the mounting axis and a defined pivot angle in the opposite direction. Preferably, at each pivot angle in which the camera is rotated about the mounting axis, a distorted, round thermal image is created, which has the advantage that a hotspot, for example a source of fire or a developing fire or glowing embers or an area with an unusually high temperature for the material monitored, which may indicate that a fire is starting, possibly even in a deeper area below the thermographically monitored surface, can be detected and marked by the image processing device and spatially assigned to an extinguishing agent sprayer.

In its design, the camera comprises a fisheye lens and the controller outputs a composite image to the screen in real time.

For power supply, the camera is connected to a power grid via a slip ring arrangement or inductively. Of course, flexible cables can also be used without departing from the scope of the invention. The camera expediently transmits image data to the controller via wired or wireless data transmission. In particular, wireless data transmission can take place via so-called Near Field Communication or in a wireless LAN or according to the so-called Bluetooth standard.

To simplify the evaluation of the images recorded by the camera and displayed on the screen and evaluated by the image processing device, the camera is designed as a thermal imaging camera and scans the monitored space in continuous pivoting movements in at least one direction, wherein an image processing device of the controller can combine the individual images of the thermal imaging camera to form a spatial image on the screen.

In an embodiment, a laser coupled to the controller is assigned to the camera and/or the extinguishing agent sprayer, wherein the laser beam of the laser assigned to the camera is directed in the direction of the camera lens and the laser beam of the laser assigned to the extinguishing agent sprayer is directed in the direction of dispensing of the extinguishing agent. Preferably, the laser of the camera and/or the extinguishing agent sprayer is designed to measure distance and/or to emit a pulsed laser beam. The distance measurement provides the controller with additional actual data, which are used to calculate the coordinates of the source of the fire and thus the required point of impact of the extinguishing agent, in particular to take into account the throw parabola of the dispensed extinguishing agent. The distance data are particularly important when the stored goods on the area to be monitored are at a relatively high height, as is the case with a constantly changing pile of rubbish in a waste bunker or a stack of tires in a tire warehouse, for example, since the two-dimensional data of the camera image are then supplemented by exact distance data that ensure a three-dimensional calculation of the target coordinates for the extinguishing agent. Pulsed operation of the laser beam simplifies clear detection of the beam through recorded images and their evaluation at the controller, using either the image recognition device or signals from the laser beam detectors.

It is understood that the features mentioned above and still to be explained below can be used not only in the respectively specified combination but also in other combinations. The scope of the invention is defined only by the claims.

The invention is explained in more detail below on the basis of an embodiment with reference to the associated drawings.

### BRIEF DESCRIPTION OF THE DRAWINGS

In the drawings:

FIG. 1 shows a schematic representation of a room to be monitored with the extinguishing system according to the invention,

FIG. 2 shows a schematic representation of a camera arrangement for generating an image,

FIG. 3 shows a schematic representation of an image,

FIG. 4 shows a view of a camera image,

FIG. 5 shows a partial representation of a camera image detail according to FIG. 4,

FIG. 6 shows a schematic representation of the transformed camera image detail according to FIG. 5,

FIG. 7 shows a schematic representation of a generated circular image,

FIG. 8 shows a second schematic representation of the arrangement according to FIG. 2,

FIG. 9 shows a schematic representation of a generated circular annular image,

FIG. 10 shows a schematic representation of a circular image composed of multiple circular annular images and one circular image,

FIG. 11 shows a third schematic representation of the arrangement according to FIG. 2,

FIG. 12 shows a fourth schematic representation of the arrangement according to FIG. 2, and

FIG. 13 shows a representation of a thermal circular image.

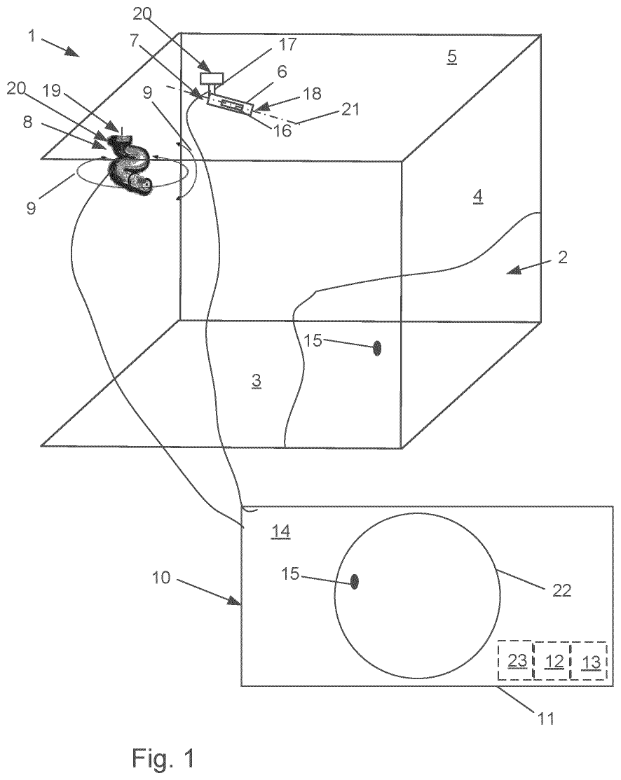

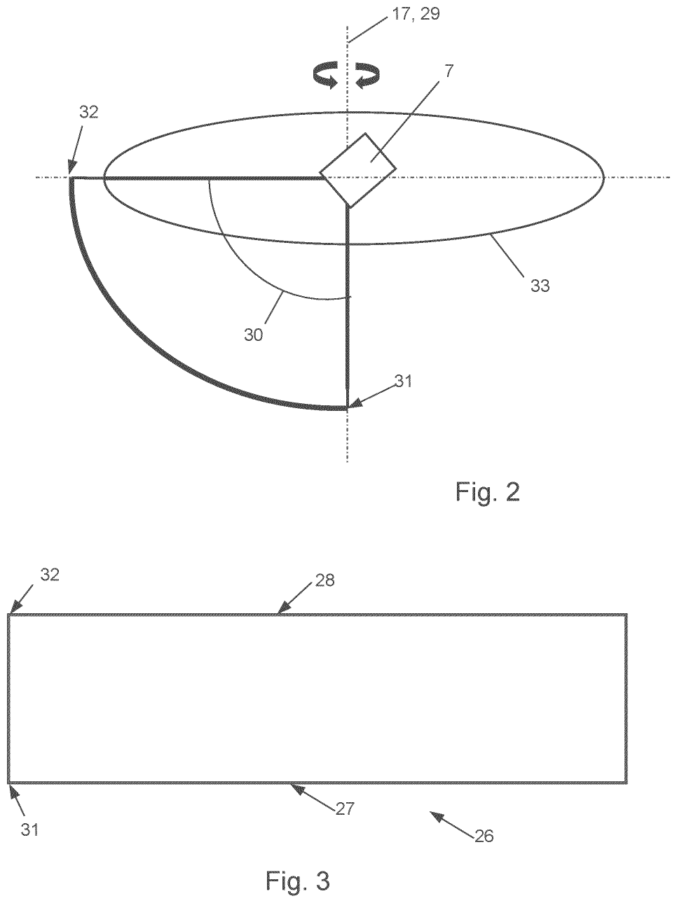

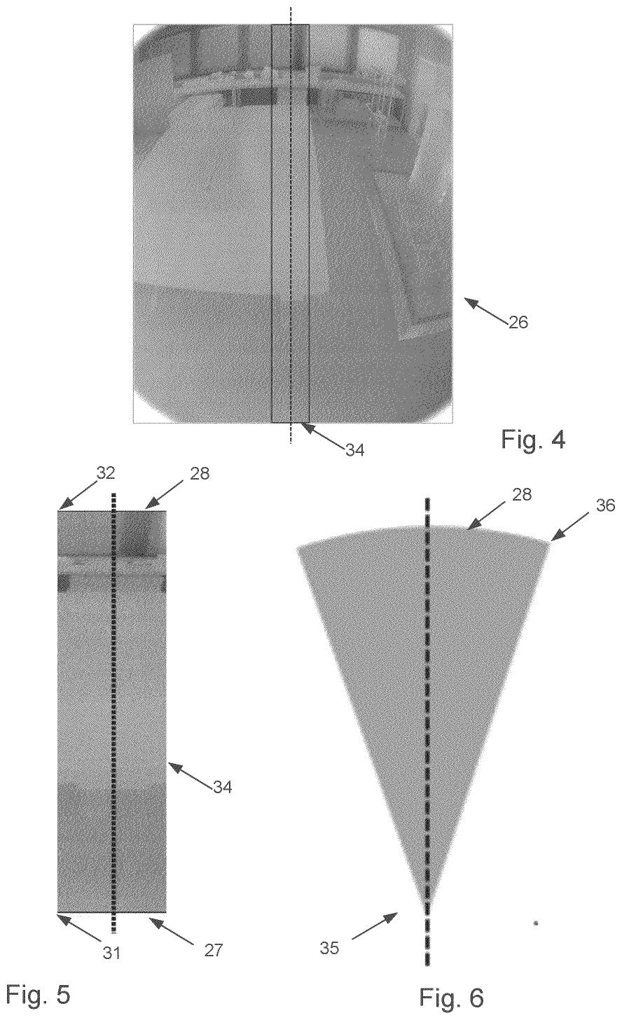

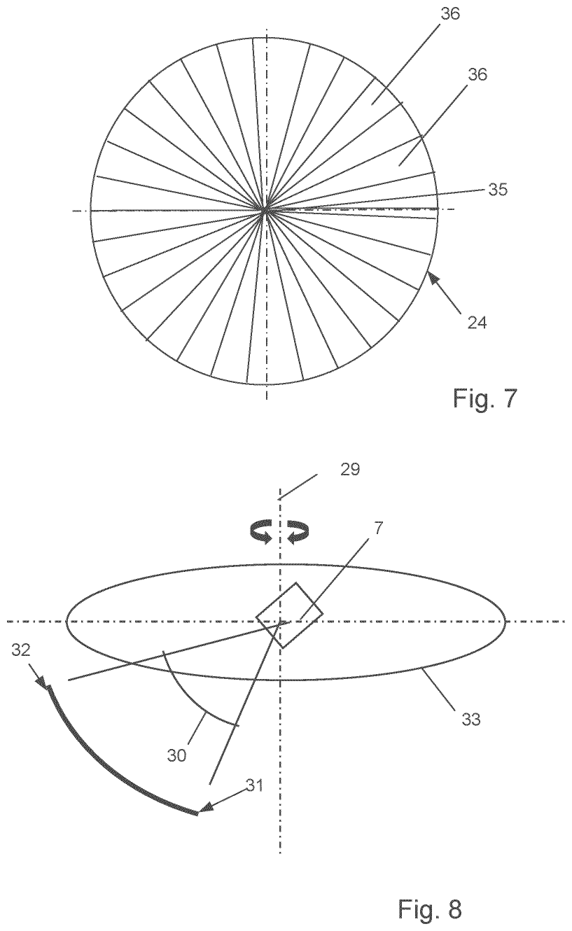

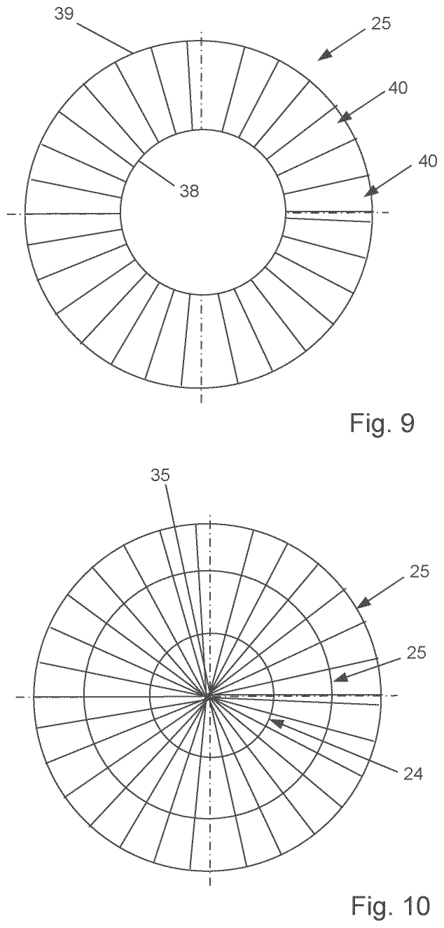

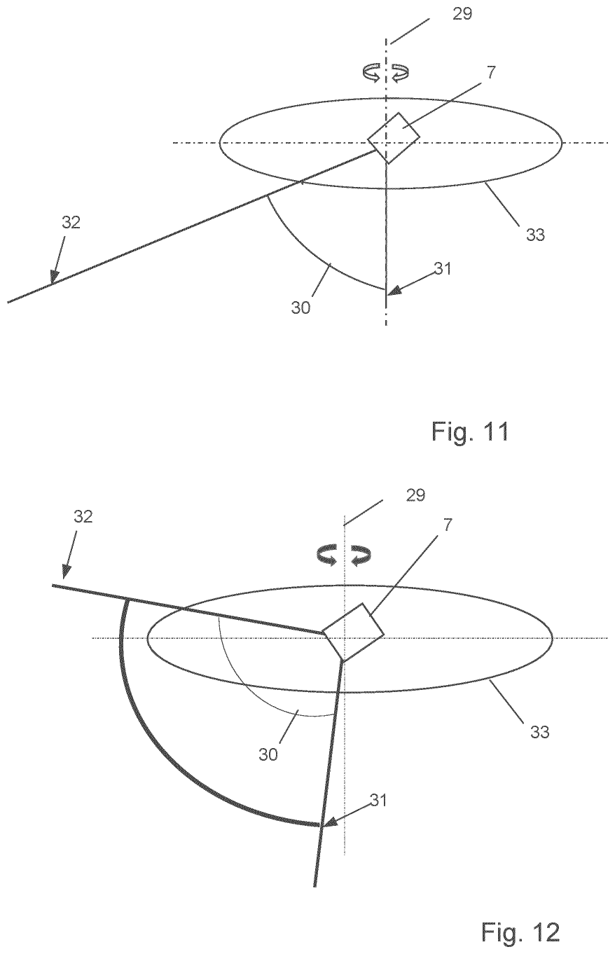

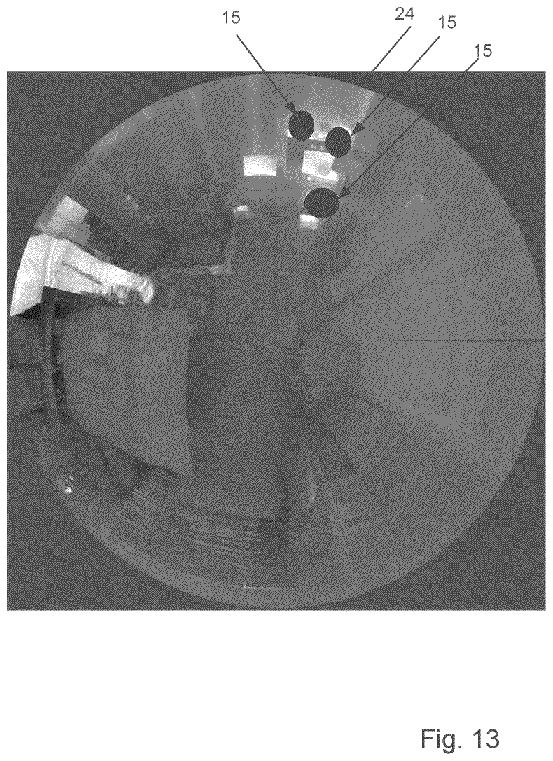

### DETAILED DESCRIPTION OF THE PREFERRED EMBODIMENTS

The room 1 to be monitored is, for example, a storage room for combustible material 2, such as tires, garbage, but also motor vehicles, plastics, or the like. The room 1 is defined by the dimensions of its base area and its height in a known manner, and is usually limited by a floor 3, side walls 4, and a ceiling 5.

In order to monitor the room 1 for the occurrence of a fire in the material 2 and, if necessary, to start an automatic extinguishing of the fire, the extinguishing system is installed, which substantially comprises a camera 7 designed as a thermal imaging camera 6 and an extinguishing agent sprayer 8, which can also be referred to as an extinguishing monitor or extinguishing sprayer. The camera 7 and the extinguishing agent sprayer 8 are mounted at certain positions on the ceiling 5 of the room in such a way that a mounting axis 17 of the camera 7, which comprises for example a lens 18 which is suitable, for example, for 24° recordings, is aligned parallel to a mounting axis 19 of the extinguishing agent sprayer 8. The camera 7 can be pivoted in an oscillating manner about the mounting axis 17 by means of a motor 20, in particular a stepper motor, by any angle of rotation up to 360°. Furthermore, the camera 7 or its optical axis 21 assumes a defined position relative to the mounting axis 17. If the room 1 to be monitored has special conditions, the camera 7 can be pivoted such that the axis 21 describes a larger or smaller angle to the mounting axis 17 and/or around the mounting axis 17.

The extinguishing monitor 8 can be pivoted about two axes, as indicated by the arrows 9 assigned to the extinguishing agent sprayer 8, namely about its mounting axis 19 and an axis aligned at an angle to it. The extinguishing agent sprayer 8 is connected to pipe or hose lines for the extinguishing agent. Furthermore, the extinguishing agent sprayer 8 is coupled to an electronic controller 10, which is designed as a tablet 11 in the present case, and comprises at least one memory unit 12 for the readable storage of data, a computer module 13 for data processing and a screen designed as a touchscreen 14, wherein the touchscreen 14 serves both as an input unit and for displaying the images recorded by the thermal imaging camera 6, wherein the thermal imaging camera 6 is of course also connected to the tablet 11.

The basic geometric data of the room 1, which are measured on site as actual data, are stored in the storage unit 12 of the electronic controller 10. These basic geometric data of the room 1 describe the floor area, i.e., the dimensions of the floor 3 and the height of the room 1. Furthermore, the coordinates at which the camera 7 and the extinguishing agent sprayer 8 are attached are stored. In addition, standard sprayer curves determined by the manufacturer, which describe the spraying distances of the extinguishing agent under a particular pressure and specified extinguishing agent sprayer settings, as well as various software and image data processing devices 23, can be stored.

The software and image data processing device 23 ensure, on the one hand, detection of a source of fire 15, in particular also excluding other irrelevant heat sources, and on the other hand a representation of the images recorded with the camera 7, which can be combined to form a representation of the entire room 1. A round thermal radar image 22 is created as a view on the touchscreen 14, which in this case shows a fire source 15 that can be designated as a hotspot, to which an extinguishing agent sprayer 8 can be directly assigned.

In addition, the tablet 11, in particular the touchscreen 14 thereof, can be used by an operator of the extinguishing system to control motors 20 assigned to the camera 7 and the extinguishing agent sprayer 8, which are preferably designed as stepper motors, for pivoting the camera 7 and the extinguishing agent sprayer 8. As an alternative to the control via touchscreen 14, a joystick can also be provided as an input device on a computer with an associated screen.

At least the camera 7 is assigned a laser 16 which is aligned in the image recording direction and which can be designed for distance measurement and/or for emitting a pulsed laser beam 18.

The positions of the fire source 15 recorded by the camera 7 can be described with a relatively low computational effort and the extinguishing agent sprayer 8 can be tracked relatively precisely, since in particular the mounting axes 17, 19 on both sides are aligned parallel to one another, so that deviations or errors of lesser importance arise due to the different mounting points as long as the distance between the extinguishing agent sprayer 8 and the camera 7 is relatively small, for example up to about 5 m, preferably up to about 2 m. However, the error is usually so small that the fire can be extinguished at this point using the extinguishing agent. The error corresponds to at most the distance between an axis 21 of the camera 7 and a quasi-dispensing axis of the extinguishing agent sprayer 8.

With the stored actual data and the coordinates of the mounting points, all points in the room 1 can be calculated on the control 10, for example by means of triangulation on the control, and the extinguishing agent sprayer 8 can be quickly aligned by correspondingly controlling the stepper motors assigned to it, so that a fire source 15 can be extinguished, wherein as an alternative to the stepper motors, for example any motors 20 with assigned position sensors can also be used.

In normal operation or regular operation, the camera 7 continuously pivots around a vertical axis to monitor the entire room 1, in particular oscillating if necessary by up to 360°. When a fire source 15 is detected, the extinguishing agent sprayer 8 is pivoted into a corresponding extinguishing position.

The thermal radar image 22 is generated on the image processing device 23 based on images recorded by the camera 7 and can be displayed either as a relatively schematic representation, which substantially only shows heat points above stored limit temperatures that can develop into fire sources 15, or as a detailed representation in which all details as well as the heat points can be recognized, wherein the schematic representation can also be switched to a detailed representation. The circular image 24, which is composed as a circular image 24 or circular annular image 25 or from successively generated circular images 24 and/or circular annular images 25, is continuously generated anew from a rectangular image 26.

The circular image 24 or circular annular image 25 can encompass any angle and, as will be apparent to a person skilled in the art, can be any size smaller than 360°. In particular, the circular images 24 or circular annular images 25 can be adapted to an object to be monitored, for example a corner region of a building or storage area. Then, for example, the camera 7 can oscillate by an angle of less than 360° and a corresponding circular image 24 or circular annular image 25 is composed and displayed.

For the present aperture angle 30 of 90°×67.5°, the rectangular image of the camera 7 has an image resolution of 640×480 pixels and begins at the bottom with a start line 27 and ends at the top with the end line 28. The camera 7 is mounted on the mounting axis 17, which represents an axis of rotation 29, in such a way that it is pivoted by 45° to the mounting axis 17 at the opening angle 30 of 90°, so that the start line 27 is aligned with the mounting axis 17 or intersects with the extension of it, and a start corner pixel 31 is almost stationary when the camera 7 is rotated. An end corner pixel 32 of the end line 28 describes a circular path 33 when the camera 7 rotates.

If the full resolution of camera 7 is assigned to the 360° circular path 33, the result is: 360° circumference/67.5° aperture angle=5.33 camera images put together.

Therefore:

5.33×480 thermal pixels per 67.5° opening angle results in a circular resolution of approx. 2,558 thermal pixels for 360° resolution.

When rotated by 360°, the thermographic rectangular image 26 is created, which is limited at the lower side by the start line 27 and at the upper side by the end line 28, and has a height of 640 thermal pixels and a length of 2,558 thermal pixels, wherein the start corner pixel 31 in the arrangement described above almost always points to the same location point below the mounting axis 17, which acts as the axis of rotation 29. In order to be able to visually interpret this rectangular image 26, small portions of the IR thermal image are recorded during rotation along with their position, and are arranged one after the other. The width of these portions varies and depends on the processing speed of the computer module 13 of the controller 10 in which these portions are joined together, and on the rotational speed of the motor 20. The narrower the portions are, the less distorted the overall image will be, but the more computing power the system will require.

To simulate a wide-angle lens of approximately 180° of an IR camera 6, a central portion 34 of the image 26, as a subportion with a width of, e.g., 40 thermal pixels, is taken as precisely as possible from the center of the image, since the smallest image distortions are present in the center of the image, because the wider the image 26 is, the greater the fisheye effect is in a recording, and the partial images can then no longer be joined together without distortion.

The central portion 34 is converted into a thermographic circular image 24, wherein the lower starting line 27 is converted to a central circular image center point 35, wherein the height of the central portion 34 of the thermal image 26 corresponds to the radius of a circular segment image 36. Each line of the central portion 34 has to be converted into a circular segment line. The closer one comes to the center of the circular image 35, the fewer thermal pixels fit into the corresponding line of the circular segment image 36. Therefore, thermal pixel groups must be formed that consist of multiple thermal pixels located next to each other. The closer you get to the center, i.e., the circular image center 35 of the circular image 24, the more thermal pixels a thermal pixel group contains.

Averaging the individual thermal pixels of a thermal pixel group leads to a smoothing of the maximum temperatures. Therefore, when a thermal pixel group is combined into a new thermal pixel, the temperature value of the hottest thermal pixel in the group is always used. The use of the maximum value when summarizing a thermal pixel group is particularly advantageous when the design described above is used for fire monitoring and displaying a fire source 15, i.e., a hotspot.

At the same time, the polar coordinates of the thermal pixels are also calculated in order to be able to immediately position an extinguishing agent sprayer 8 onto the source of the fire 15 in the event of a fire alarm. When calculating the polar coordinates, data from a position sensor on the mounting axis 19 can be determined and processed at the controller 10. The alignment of the extinguishing agent sprayer 8 can be simplified by the laser 16 assigned to the camera 7 in order to take into account the spraying parabola of the dispensed extinguishing agent.

To display a circular image 24 on the touchscreen 14, multiple circular segment images 36 are arranged one after the other and are also overwritten as the camera 7 continues to rotate.

If a camera 7 with an aperture angle 30 smaller than 90° is selected, for example, to monitor a partial area of the room 1, then the start corner pixel 31 is not aligned with the mounting axis 17 and describes a circular path that is concentric with the circular path 33 of the end corner pixel 32.

Here too, a central portion 34 is extracted from the image 26 and converted into a thermographic circular annular image 25, so that the lower start line 27 is converted to an inner diameter 38 and the upper end line 28 is converted to an outer diameter 39 of a circular sector image 40, wherein the height of the central portion 34 of the thermal image corresponds to the difference between the outer diameter 39 and the inner diameter 38 of the circular sector image 40. The circular sector images 40 resulting from the rotation of the camera 7 are continuously combined to form the circular annular image 25.

Of course, circular images 24 and/or circular annular images 25 or corresponding combinations with any angle smaller than 360° can also be generated and displayed, in particular depending on the angle of rotation of the camera 7 or controlled by the image processing device 23.

To change the diameter or area to be monitored in the room 1, a camera 7 with an aperture angle 30 smaller than 90° is selected and aligned such that the start corner pixel 31 is aligned with the axis of rotation 29 and the end corner pixel 32 describes a circular path that is aligned concentrically with the circular path 33 and has a diameter that is different from it. As already described, a circular image 24 is generated and displayed.

If an area above the mounting of the camera 7 in the room 1, for example a ceiling 5, is to be monitored, then a camera 7 with an aperture angle 30 of 90° can be selected and aligned such that the start corner pixel 31 is not in alignment with the mounting axis 17 and the end corner pixel 32 describes a circular path that is aligned concentrically to the circular path 33 and has a different diameter compared to it. As already described, a circular annular image 25 is generated and displayed.

It is obvious to the person skilled in the art that with the camera 7, by pivoting it relative to the mounting axis 17, for example a circular image 24 and multiple circular annular images 25, or multiple circular annular images 25 without a central circular image 24 with different diameters, can be generated one after the other and aligned concentrically to one another in a common representation in order to be able to capture a relatively large space 1, both centrally and in peripheral edge regions.

### LIST OF REFERENCE NUMERALS

1. Room
2. Material
3. Floor
4. Side wall
5. Ceiling
6. Thermal imaging camera
7. Camera
8. Extinguishing agent sprayer
9. Arrow
10. Controller
11. Tablet
12. Storage unit
13. Computer module
14. Touchscreen
15. Source of the fire
16. Laser of 7
17. Mounting axis of 7
18. Lens
19. Mounting axis of 8
20. Motor
21. Axis
22. Thermal radar image
23. Image data processing device
24. Circular image
25. Circular annular image
26. Image
27. Start line
28. End line
29. Axis of rotation
30. Opening angle
31. Start corner pixel
32. End corner pixel
33. Circular path
34. Middle portion
35. Center of the circular image
36. Circular segment image
37.
38. Diameter
39. Diameter
40. Circle sector image

1. An extinguishing system, having
at least one extinguishing agent sprayer (8) that is able to be rotated about a mounting axis (19) by means of at least one motor and is connected to an extinguishing agent line in order to be supplied with extinguishing agent,
at least one camera (7) that is able to be rotated at least about a mounting axis (17) by means of at least one motor (20),
an electronic controller (10) that comprises at least one storage unit (12) in which at least geometric basic data of the relevant area and/or data of the extinguishing agent sprayer (8) are stored so as to be able to be read, and a computer module (13) for data processing,
an input device, connected to the controller (10), for inputting data and/or for controlling the extinguishing agent sprayer (8) and the camera (7), and
a screen, connected to the controller (10), for displaying images from the camera (7),
characterized in that the mounting axis (17) of the camera (7) and the mounting axis (19) of the extinguishing agent sprayer (8) are aligned parallel to each other and the optical axis (21) of the camera (7) is aligned at a defined starting angle to the mounting axis (17), wherein the starting angle is stored in the storage unit (12).

2. The extinguishing system according to claim 1, characterized in that the camera (7) is driven to rotate from a zero position in an oscillating or continuously rotating manner about the mounting axis (17).

3. The extinguishing system according to claim 1, characterized in that the camera (7) is capable of being rotated radially by up to 360° around the mounting axis (17) from a zero position.

4. The extinguishing system according to claim 1, characterized in that the camera (7) is capable of being pivoted from the defined starting angle to the mounting axis (17) by a defined pivot angle in the direction of the mounting axis (17) and a defined pivot angle in the opposite direction.

5. The extinguishing system according to claim 1, characterized in that the camera (7) comprises a fisheye lens and the controller (10) outputs a composite image in real time on the screen.

6. The extinguishing system according to claim 1, characterized in that the camera (7) is connected to a power network via a slip ring arrangement or inductively or by a wired connection.

7. The extinguishing system according to claim 1, characterized in that the camera (7) transmits image data to the controller (10) by means of a wired or wireless data transmission.

8. The extinguishing system according to claim 1, characterized in that the substrate (7) is designed as a thermal imaging camera (6).

9. The extinguishing system according to claim 1, characterized in that a laser (16) coupled to the controller (10) is assigned to the camera (7) and/or the extinguishing agent sprayer (8), wherein the laser beam of the laser (16) assigned to the camera (7) is aligned in the direction of the lens of the camera (7).

10. The extinguishing system according to claim 9, characterized in that the laser (16) of the camera (7) and/or of the extinguishing agent sprayer (8) is designed for distance measurement and/or for emitting a pulsed laser beam.

11. The extinguishing system according to claim 1, characterized in that the motors (20) assigned to the camera (7) and/or to the extinguishing agent sprayer (8) for rotation or pivoting are designed as stepper motors coupled to the controller (10).
